(19) United States
(12) Patent Application Publication
(10) Pub. No.: US 2026/0149992 A1
(43) Pub. Date: May 28, 2026

(54) MEASUREMENT METHOD AND APPARATUS, DEVICE, AND READABLE STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 19/120,333

(22) PCT Filed: Oct. 14, 2022
(86) PCT No.: PCT/CN2022/125474

§ 371 Date: Apr. 11, 2025

(51) Int. Cl. H04W 24/10; H04L 5/00; H04W 52/02; H04W 56/00

(52) U.S. Cl. CPC H04W 24/10; H04L 5/0048; H04W 52/0229; H04W 56/00

(57) ABSTRACT

The present disclosure provides a measurement method and apparatus, a device, and a readable storage medium, applied to the technical field of wireless communications. The method includes: measuring a first reference signal by using a low-power-consumption receiver so as to obtain a first measurement result, wherein the first reference signal is a signal sent by a neighbor cell of a user equipment, and the first reference signal is used for reception of the low-power-consumption receiver.

### CROSS REFERENCE

The present application is a national phase application of International Application No. PCT/CN2022/125474, filed on Oct. 14, 2022, and the entire contents thereof are incorporated herein by reference.

### TECHNICAL FIELD

The present disclosure relates to the field of wireless communication technology, and in particular to a measurement method, apparatus, device, and readable storage medium.

### BACKGROUND

Mobility measurement is an important part of wireless communication networks. User equipment can obtain the signal quality of the serving cell and neighboring cells by performing mobility measurement, and report the relevant measurement results to the network device. The network device determines whether the terminal device performs cell handover based on the measurement results reported by the terminal device.

In the next generation wireless communication network (new radio, NR), the network device can configure the synchronization signal block (SSB) or channel state information reference signal (CSI-RS) for the terminal device for mobility measurement.

In order to save power consumption of the user equipment, a main transceiver and a low-power receiver are configured in the user equipment. The user equipment can put the main transceiver in a dormancy state, and then monitor the low-power wake-up signal (LP WUS) with the low-power receiver. After the LP WUS being monitored, the main transceiver is woken up, and data is received and sent through the main transceiver.

It should be noted that, information disclosed in the above background portion is provided only for better understanding of the background of the present disclosure, and thus it may contain information that does not form the prior art known by those ordinary skilled in the art.

### SUMMARY

The present disclosure provides a measurement method, an apparatus, a device, and a readable storage medium.

In a first aspect, a measurement method is provided, which is performed by a user equipment, and the method includes:
measuring a first reference signal using a low-power receiver to obtain a first measurement result, wherein the first reference signal is a signal sent by a neighboring cell of the user equipment, and the first reference signal is used for reception by the low-power receiver.

In some possible implementations, the first reference signal is a periodic low-power wake-up signal or a periodic synchronization signal.

In some possible implementations, the method further includes:
receiving measurement configuration information sent by a network device, wherein the measurement configuration information is used to indicate that the first reference signal is used as a measurement signal.

In some possible implementations, the measurement configuration information includes at least one piece of measurement window configuration information, wherein the measurement window configuration information includes at least one of: a window period, a window length, a window time domain offset, or a window frequency domain position.

In some possible implementations, the method further includes: receiving first configuration information sent by a network device, wherein the first configuration information is configuration information of the first reference signal sent by the neighboring cell.

In some possible implementations, the first configuration information includes at least one of: a period, a time domain offset, or a frequency domain position.

In some possible implementations, the method further includes:
measuring a second reference signal using the low-power receiver to obtain a second measurement result, wherein the second reference signal is a signal sent by a serving cell of the user equipment.

In some possible implementations, the method further includes:
receiving second configuration information sent by a network device, where the second configuration information is configuration information of the second reference signal sent by the serving cell.

In some possible implementations, the measuring the first reference signal using the low-power receiver includes: determining, according to the second measurement result, whether to measure the first reference signal using the low-power consumption receiver to obtain the first measurement result.

In some possible implementations, wherein determine, according to the second measurement result, to measure the first reference signal using the low-power consumption receiver, includes:
in a case that the second measurement result is lower than a first threshold value, measuring the first reference signal using the low-power receiver, wherein a frequency of the neighboring cell is the same as a frequency of the serving cell; or,
in a case that the second measurement result is lower than a second threshold value, measuring the first reference signal using the low-power receiver, wherein the frequency of the neighboring cell is different from the frequency of the serving cell.

In some possible implementations, the method further includes:
waking up a main receiver in a case that the first measurement result is lower than a third threshold value and the second measurement result is lower than a fourth threshold value.

In some possible implementations, the method further includes:
using the measurement configuration information to indicate that the first reference signal of the neighboring cell with a first priority is used as the measurement signal.

In some possible implementations, the method further includes:
determining at least one neighboring cell according to the first measurement result, and monitoring the low-power wake-up signal of the at least one neighboring cell.

In some possible implementations, determining at least one neighboring cell according to the first measurement result includes:
determining a neighboring cell that meets at least one of following conditions according to the first measurement result:
a measurement value in the first measurement result being highest;
the measurement value in the first measurement result being greater than a fifth threshold value; or
the measurement value in the first measurement result being greater than a sixth threshold value and the neighboring cell having a first priority.

In some possible implementations, the method further includes: determining at least one neighboring cell according to the first measurement result and the second measurement result, and monitoring a low-power wake-up signal of the at least one neighboring cell.

In some possible implementations, the determining at least one neighboring cell according to the first measurement result and the second measurement result includes: determining a neighboring cell satisfying at least one of:
the first measurement result being better than the second measurement result, and a difference between the first measurement result and the second measurement result being greater than or equal to a seventh threshold value; or
a value representing a degree to which the first measurement result is superior to the second measurement result being greater than an eighth threshold value.

A second aspect provides a method for sending measurement configuration information, performed by a network device, the method including:
sending measurement configuration information to a user equipment, wherein the measurement configuration information is used to indicate that a first reference signal is used as a measurement signal, wherein the first reference signal is a signal sent by a neighboring cell of the user equipment, and the signal is used for reception by a low-power receiver.

In some possible implementations, the signal is a periodic low-power wake-up signal or a periodic synchronization signal.

In some possible implementations, the measurement configuration information includes at least one piece of measurement window configuration information, and the measurement window configuration information includes at least one of: a window period, a window length, a window time domain offset, or a window frequency domain position.

In some possible implementations, the method further includes:
sending first configuration information to the user equipment, wherein the first configuration information is configuration information of the first reference signal sent by the neighboring cell.

In some possible implementations, the method further includes:
sending second configuration information to the user equipment, wherein the second configuration information is configuration information of the second reference signal sent by a serving cell.

In some possible implementations, the method further includes:
determining a neighboring cell with a first priority among neighboring cells of the user equipment; and
using the measurement configuration information to indicate that the first reference signal of the neighboring cell with the first priority is used as the measurement signal.

A third aspect provides a measuring apparatus, configured in a user equipment, wherein the apparatus includes:
a transceiver module, configured to measure a first reference signal using a low-power receiver to obtain a first measurement result, wherein the first reference signal is a signal sent by a neighboring cell of the user equipment, and the first reference signal is used for reception by the low-power receiver.

A fourth aspect provides an apparatus for sending measurement configuration information, configured in a network device, wherein the apparatus includes:
a transceiver module, configured to send the measurement configuration information to a user equipment, wherein the measurement configuration information is used to indicate that a first reference signal is used as a measurement signal, wherein the first reference signal is a signal sent by a neighboring cell of the user equipment, and the signal is used for reception by a low-power receiver.

A fifth aspect provides an electronic device, including a processor and a memory, wherein:
the memory is configured to store a computer program; and
the processor is configured to execute the computer program to implement the first aspect or any possible design of the first aspect.

A sixth aspect provides an electronic device, including a processor and a memory, wherein:
the memory is configured to store a computer program; and
the processor is configured to execute the computer program to implement the second aspect or any possible design of the second aspect.

A seventh aspect provides a computer-readable storage medium, wherein instructions are stored in the computer-readable storage medium, and when the instructions are called and executed on a computer, the computer the first aspect or any possible design of the first aspect.

An eighth aspect provides a computer-readable storage medium, wherein instructions are stored in the computer-readable storage medium, and when the instructions are called and executed on a computer, the computer executes the second aspect or any possible design of the second aspect.

It is to be understood that the foregoing general description and the following detailed description are exemplary and explanatory only and are not restrictive of the present disclosure.

### BRIEF DESCRIPTION OF THE DRAWINGS

The drawings described herein are used to provide a further understanding of the embodiments of the present disclosure and constitute a part of this application. The illustrative embodiments of the embodiments of the present disclosure and their descriptions are used to explain the embodiments of the present disclosure and do not constitute an improper limitation on the embodiments of the present disclosure. In the drawings:

The accompanying drawings herein are incorporated in and constitute a part of the specification, illustrate embodiments consistent with the embodiments of the present disclosure, and together with the description, serve to explain the principles of the embodiments of the present disclosure.

FIG. 1 is a schematic diagram of a wireless communication system architecture provided by an embodiment of the present disclosure;

FIG. 2 is a schematic diagram of a method for sending measurement configuration information and measuring provided by an embodiment of the present disclosure;

FIG. 3 is a schematic diagram of a method for sending measurement configuration information and measuring provided by an embodiment of the present disclosure;

FIG. 4 is a schematic diagram of a method for sending measurement configuration information and measuring provided by an embodiment of the present disclosure;

FIG. 5 is a schematic diagram of a method for sending measurement configuration information and measuring provided by an embodiment of the present disclosure;

FIG. 6 is a flow chart of a measurement method provided by an embodiment of the present disclosure;

FIG. 7 is a flow chart of a measurement method provided by an embodiment of the present disclosure;

FIG. 8 is a flow chart of a measurement method provided by an embodiment of the present disclosure;

FIG. 9 is a flow chart of a measurement method provided by an embodiment of the present disclosure;

FIG. 10 is a flow chart of sending measurement configuration information provided by an embodiment of the present disclosure;

FIG. 11 is a flow chart of sending measurement configuration information provided by an embodiment of the present disclosure;

FIG. 12 is a structural diagram of a measuring apparatus provided in an embodiment of the present disclosure;

FIG. 13 is a structural diagram of a measuring apparatus provided in an embodiment of the present disclosure;

FIG. 14 is a structural diagram of an apparatus for sending measurement configuration information provided by an embodiment of the present disclosure; and

FIG. 15 is a structural diagram of an apparatus for sending measurement configuration information provided by an embodiment of the present disclosure.

### DETAILED DESCRIPTION

The embodiments of the present disclosure are now further described in conjunction with the accompanying drawings and specific implementation methods.

Exemplary embodiments will be described in detail herein, examples of which are shown in the accompanying drawings. When the following description refers to the drawings, the same numbers in different drawings represent the same or similar elements unless otherwise indicated. The implementations described in the following exemplary embodiments do not represent all implementations consistent with the embodiments of the present disclosure. Instead, they are merely examples of devices and methods consistent with some aspects of the present disclosure as detailed in the appended claims.

The terms used in the disclosed embodiments are only for the purpose of describing specific embodiments and are not intended to limit the disclosed embodiments. The singular forms of “a” and “the” used in the disclosed embodiments and the appended claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the disclosed embodiments, the information should not be limited to these terms. These terms are only used to distinguish the same type of information from each other. For example, without departing from the scope of the disclosed embodiments, the first information may also be referred to as the second information, and similarly, the second information may also be referred to as the first information. Depending on the context, the words “if” and “in case” as used herein may be interpreted as “at” or “when” or “in response to determination”.

The embodiments of the present disclosure are described in detail below, and examples of the embodiments are shown in the accompanying drawings, wherein the same or similar reference numerals throughout represent the same or similar elements. The embodiments described below with reference to the accompanying drawings are exemplary and are intended to be used to explain the present disclosure, and cannot be understood as limiting the present disclosure.

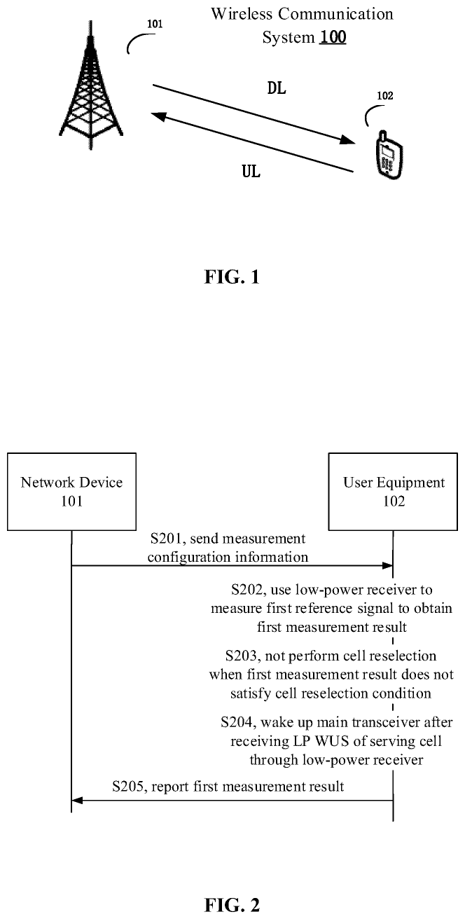

As shown in FIG. 1, a method for executing indication information provided by an embodiment of the present disclosure may be applied to a wireless communication system 100, which may include but is not limited to a network device 101 and a user equipment 102. The user equipment 102 is configured to support carrier aggregation, and the user equipment 102 may be connected to multiple carrier components of the network device 101, including a primary carrier component and one or more secondary carrier components.

It should be understood that the above wireless communication system 100 can be applied to both low-frequency scenarios and high-frequency scenarios. Application scenarios of the wireless communication system 100 include, but are not limited to, long term evolution (LTE) systems, LTE frequency division duplex (FDD) systems, LTE time division duplex (TDD) systems, worldwide interoperability for micro wave access (WiMAX) communication systems, cloud radio access network (CRAN) systems, future fifth generation (5G) systems, new radio (NR) communication systems, or future evolved public land mobile network (PLMN) systems.

The user equipment 102 shown above may be a user equipment (UE), a terminal, an access terminal, a terminal unit, a terminal station, a mobile station (MS), a remote station, a remote terminal, a mobile terminal, a wireless communication device, a terminal agent or a user equipment, etc. The user equipment 102 may have a wireless transceiver function, and it may communicate (such as wireless communication) with one or more network devices 101 of one or more communication systems, and receive network services provided by the network device 101, where the network device 101 includes but is not limited to the base station shown in the drawings.

The user equipment 102 may be a cellular phone, a cordless phone, a session initiation protocol (SIP) phone, a wireless local loop (WLL) station, a personal digital assistant (PDA) device, a handheld device with wireless communication capabilities, a computing device or other processing device connected to a wireless modem, a vehicle-mounted device, a wearable device, a user equipment in a future 5G network, or a user equipment in a future evolved PLMN network, etc.

The network device 101 may be an access network device (or access network station). The access network device refers to a device that provides network access functions, such as a radio access network (RAN) base station, etc. The network device may specifically include a base station (BS) device, or a base station device and a wireless resource management device for controlling the base station device, etc. The network device may also include a relay station (relay device), an access point, a base station in a future 5G network, a base station in a future evolved PLMN network, or an NR base station, etc. The network device may be a wearable device or a vehicle-mounted device. The network device may also be a communication chip with a communication module.

For example, the network device 101 includes but is not limited to: a next-generation base station (gnodeB, gNB) in 5G, an evolved node B (eNB) in an LTE system, a radio network controller (RNC), a node B (NB) in a WCDMA system, a wireless controller under a CRAN system, a basestation controller (BSC), a base transceiver station (BTS) in a GSM system or a CDMA system, a home base station (for example, home evolved nodeB, or home node B, HNB), a baseband unit (BBU), a transmitting and receiving point (TRP), a transmitting point (TP) or a mobile switching center, etc.

When the main transceiver of the user equipment is in the operating state, in order to enable the user equipment to smoothly perform mobility measurement, the network device may configure one or more measurement objects for the user equipment, and when each measurement object contains a synchronization signal block for mobility measurement configured by the network device for the user equipment, the frequency position, subcarrier spacing, etc. of the synchronization signal block will be indicated. Similarly, when the network device configures CSI-RS resources for mobility measurement for the user equipment, the frequency position, subcarrier spacing, etc. of the CSI-RS will also be indicated.

When the main transceiver of the user equipment is in dormancy mode, it will not be able to use the synchronization signal block or CSI-RS resources to perform mobility measurement. Considering that a feasible solution is to use the signal received by the low-power receiver to perform mobility measurement.

The embodiment of the present disclosure provides a measurement method. FIG. 2 is a flow chart showing a method for performing a measurement according to an exemplary embodiment. As shown in FIG. 2, the method includes steps S201 to S203. Specifically:
Step S201: The network device sends measurement configuration information to the user equipment.

The measurement configuration information is used to indicate that a first reference signal is used as a measurement signal, the first reference signal is a signal sent by a neighboring cell of the user equipment, and the signal is used to be received by a low-power receiver.

Since the low-power receiver can receive LP WUS and thus the user equipment can use LP WUS for mobility measurement, the first reference signal can be a low-power wake-up signal. Since the low-power wake-up signal can be periodic, the first reference signal is a periodic low-power wake-up signal.

In view of the fact that, in order to enable the low-power receiver to maintain the local clock, a synchronization signal for maintaining the local clock can be specially designed for the low-power receiver, for example, the synchronization signal can be: an on-off keying (OOK) or frequency shift keying (FSK) modulation signal. Thus, the user equipment can use this synchronization signal to perform mobility measurement, and the first reference signal can be a synchronization signal, and the synchronization signal is used for the low-power receiver to maintain the local clock. Since the synchronization signal can be periodic, the first reference signal is a periodic synchronization signal. This synchronization signal can be a separate synchronization signal unrelated to the LP WUS, or it can be included in the LP WUS.

In some possible implementations, the measurement configuration information includes at least one piece of measurement window configuration information, and the measurement window configuration information includes at least one of the following: a window period, a window length, a window time domain offset, and a window frequency domain position. The measurement configuration information may include multiple pieces of different measurement window configuration information. The user equipment may use any measurement window configuration information of the multiple pieces of different measurement window configuration information to perform mobility measurement, or may use different measurement window configuration information under different conditions. This condition may be a time period, a geographical location of the user equipment, and the like. For example, different measurement windows correspond to first reference signals to be measured from different neighboring cells. When the user is in a specific geographical location, only the first reference signal of the neighboring cell that is most adjacent to the geographical location is selected for measurement, therefore it is sufficient to measure the first reference signal only in the measurement window corresponding to the neighboring cell.

It can be understood that the signal sent by the neighboring cell of the user equipment is a signal sent by a network device corresponding to the neighboring cell of the serving cell of the user equipment.

Step S202: The user equipment uses a low-power receiver to measure a first reference signal to obtain a first measurement result.

In some possible implementations, the user equipment using the low-power receiver to measure the first reference signal, including: when the main transceiver of the user equipment is in a dormancy state, the user equipment uses the low-power receiver to measure the first reference signal to obtain the first measurement result.

In some possible implementations, the user equipment using the low-power receiver to measure the first reference signal, including: the user equipment uses the low-power receiver to measure the first reference signal according to configuration information of the first reference signal.

The user equipment may obtain the configuration information of the first reference signal in different ways. For example, the user equipment may obtain the configuration information of the first reference signal in the following two ways:

First, default configuration information is pre-stored in the user equipment, and the configuration information is configuration information of the first reference signal. The configuration information includes at least one of the following: a period, a time domain offset, or a frequency domain position.

Second, the user equipment receives first configuration information sent by the network device, where the first configuration information is configuration information of the first reference signal sent by the neighboring cell, and the first configuration information includes at least one of the following: period, time domain offset, or frequency domain position.

In some possible implementations, the first measurement result is one of the following:
Reference Signal Receiving Power (RSRP),
Received Signal Strength Indicator (RSSI), or
Reference Signal Receiving Quality (RSRQ), where RSRQ is the ratio of RSRP to RSSI.

Step S203: When the first measurement result does not satisfy the cell reselection condition, the user equipment does not perform cell reselection (i.e., is camped in the current serving cell).

In some possible implementations, the cell reselection condition is related to the first measurement result. For example, when the measurement value of the first measurement result does not meet the cell reselection condition, cell reselection is not performed. When the measurement value of the first measurement result meets the cell reselection condition, cell reselection is performed based on the first measurement result.

Step S204: After receiving the LP WUS of the serving cell through the low-power receiver, the user equipment wakes up the main transceiver.

That is, the user equipment is camped in the original serving cell and receives the LP WUS sent by the original serving cell. If the user equipment receives the LP WUS sent by the original serving cell, the user equipment will wake up the main transceiver.

Step S205: Report the first measurement result through the main transceiver.

The embodiments of the present disclosure are applicable to various scenarios in which a user equipment needs to perform mobility measurement, including a scenario in which the user equipment needs to perform mobility measurement when it moves to the edge of a serving cell, or a scenario in which the user equipment needs to perform mobility measurement periodically, or a scenario in which the user equipment determines that a mobility measurement condition is met based on the signal quality of the serving cell.

In the disclosed embodiment, the user equipment performs mobility measurement on the signal of the neighboring cell through the low-power receiver according to the first measurement configuration information configured by the network device, and can smoothly complete the mobility measurement when the main transceiver is in the dormancy state, thereby improving the measurement capability of the user equipment.

The embodiment of the present disclosure provides a measurement method, which includes steps S201′-S203′, specifically:
Step S201′ is the same as step S201;
Step S202′ is the same as step S202;
Step S203′: when the first measurement result meets the cell reselection condition, the user equipment performs cell reselection according to the first measurement result, and monitors the LP WUS of the reselected neighboring cell.

In some possible implementations, the cell reselection condition is related to the first measurement result. For example, when the measurement value of the first measurement result does not meet the cell reselection condition, the cell reselection condition is not performed. When the measurement value of the first measurement result meets the cell reselection condition, the cell reselection is performed according to the first measurement result.

In some possible implementations, performing cell reselection according to the first measurement result includes determining at least one neighboring cell according to the first measurement result.

In one example, determining at least one neighboring cell according to the first measurement result includes: determining a neighboring cell that meets at least one of the following conditions according to the first measurement result:
The first measurement result having the highest measured value,
The measured value in the first measurement result being greater than the fifth threshold value, or
The measurement value in the first measurement result being greater than a sixth threshold value and the neighboring cell having the first priority.

In the disclosed embodiment, the user equipment can successfully complete the mobility measurement and cell reselection when the main transceiver is in the dormancy state, thereby improving the measurement capability and cell reselection capability of the user equipment.

After the user equipment completes the cell reselection, the process may further include step S204′.

Step S204′: After receiving the LP WUS of the neighboring cell through the low-power receiver, the user equipment wakes up the main transceiver.

That is, after performing cell reselection, the user equipment receives the LP WUS signal of the neighboring cell determined after the reselection, and determines to wake up the main transceiver accordingly.

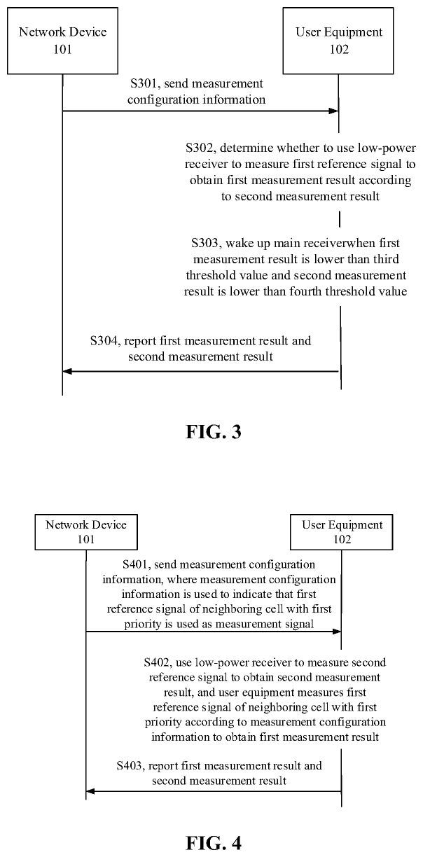

Embodiments of the present disclosure provide a measurement method. FIG. 3 is a flow chart of a measurement method according to an exemplary embodiment. As shown in FIG. 3, the method includes steps S301 to S304. Specifically:
Step S301: A network device sends measurement configuration information to a user equipment, where the measurement configuration information is used to indicate that a first reference signal is used as a measurement signal.

The measurement configuration information is used to indicate that a first reference signal is used as a measurement signal, the first reference signal is a signal sent by a neighboring cell of the user equipment, and the signal is used to be received by a low-power receiver.

Since the low-power receiver can receive LP WUS and thus the user equipment can use LP WUS for mobility measurement, the first reference signal can be a low-power wake-up signal. Since the low-power wake-up signal can be periodic, the first reference signal is a periodic low-power wake-up signal.

In view of the fact that the low-power receiver needs to receive a synchronization signal to maintain a local clock, so that the user equipment can use this synchronization signal to perform mobility measurement, the first reference signal can be a synchronization signal, and the synchronization signal is used for the low-power receiver to maintain the local clock. Since the synchronization signal can be periodic, the first reference signal is a periodic synchronization signal. This synchronization signal can be a separate synchronization signal independent from the LP WUS, or it can be included in the LP WUS.

In some possible implementations, the measurement configuration information includes at least one piece of measurement window configuration information, and the measurement window configuration information includes at least one of the following: a window period, a window length, a window time domain offset, and a window frequency domain position. The measurement configuration information may include multiple pieces of different measurement window configuration information. The user equipment may use any measurement window configuration information of the multiple pieces of different measurement window configuration information to perform mobility measurement, or may use different measurement window configuration information under different conditions. This condition may be a time period, a location, etc.

It can be understood that the signal sent by the neighboring cell of the user equipment is a signal sent by a network device corresponding to a cell adjacent to the serving cell of the user equipment.

Step S302: The user equipment uses the low-power receiver to measure a second reference signal to obtain a second measurement result, and determines whether to use the low-power receiver to measure the first reference signal to obtain the first measurement result according to the second measurement result.

The second reference signal is a signal sent by a serving cell of the user equipment.

The user equipment may obtain the configuration information of the first reference signal and the configuration information of the second reference signal in different ways. For example:

The ways for obtaining the configuration information of the first reference signal include the following two types:

In the first type, default configuration information is pre-stored in the user equipment, and the configuration information is configuration information of the first reference signal. The configuration information includes at least one of the following: a period, a time domain offset, or a frequency domain position.

In the second type, the user equipment receives first configuration information sent by the network device, where the first configuration information is configuration information of the first reference signal sent by the neighboring cell, and the first configuration information includes at least one of the following: a period, a time domain offset, or a frequency domain position.

The ways for the user equipment to obtain the configuration information of the second reference signal include the following two types:

In the first type, default configuration information is pre-stored in the user equipment, and the configuration information is configuration information of the second reference signal. The configuration information includes at least one of the following: a period, a time domain offset, or a frequency domain position.

In the second type, the user equipment receives second configuration information sent by the network device, where the second configuration information is configuration information of the second reference signal sent by the serving cell, and the second configuration information includes at least one of the following: a period, a time domain offset, or a frequency domain position.

In some possible implementations, determining, according to the second measurement result, to use the low-power receiver to measure the first reference signal includes any one of the following:

The first one is that when the second measurement result is lower than a first threshold value T1, the low-power receiver is used to measure the first reference signal, wherein the frequency of the neighboring cell is the same as the frequency of the serving cell.

It can also be understood that when the second measurement result is lower than the first threshold value T1, the low-power receiver is enabled and used to measure the first reference signal of the neighboring cell with the same frequency as the serving cell.

The second type is that when the second measurement result is lower than a second threshold value T2, the low-power receiver is used to measure the first reference signal, wherein the frequency of the neighboring cell is different from the frequency of the serving cell.

It can also be understood that when the second measurement result is lower than the second threshold value T2, the low-power receiver is enabled and used to measure the first reference signal of the neighboring cell with a frequency different from that of the serving cell.

In some possible implementations, determining not to use the low-power receiver to measure the first reference signal according to the second measurement result includes: when the second measurement result is higher than the first threshold value T1 or the second threshold value T2, not using the low-power receiver to measure the first reference signal. It can also be understood that when the second measurement result is good, there is no need to measure the first reference signal of the neighboring cell.

In some possible implementations, step S302 further includes: determining at least one neighboring cell according to the first measurement result and the second measurement result, and monitoring a low-power wake-up signal of the at least one neighboring cell.

In an example, determining at least one neighboring cell according to the first measurement result and the second measurement result includes determining a neighboring cell that satisfies at least one of the following:
The first type is that the first measurement result is better than the second measurement result, and the difference between the first measurement result and the second measurement result is greater than or equal to a seventh threshold value; or
The second type is that a value representing the degree to which the first measurement result is superior to the second measurement result is greater than an eighth threshold value.

The value representing the degree may be a ratio of a difference between the first measurement result and the second measurement result to the first measurement result, the second measurement result or a fixed value, or may be a logarithmic representation of the degree to which the first measurement result is superior to the second measurement result.

Step S303: when the first measurement result is lower than the third threshold value and the second measurement result is lower than the fourth threshold value, wake up the main receiver.

In this step S303, if the first measurement result is lower than the third threshold value and the second measurement result is lower than the fourth threshold value, it means that the signal quality of the first reference signal of the neighboring cell and the signal quality of the second reference signal of the serving cell are poor, and it cannot determine how to perform cell reselection using only the low-power receiver. Therefore, the main receiver has to be waken up to perform measurement and determine whether it is needed and how to perform cell reselection.

In one example, the third threshold value is the same as the fourth threshold value, and in another example, the third threshold value is different from the fourth threshold value.

Step S304: After waking up the main transceiver, the user equipment reports the first measurement result and the second measurement result to the network device.

The embodiments of the present disclosure are applicable to various scenarios in which a user equipment needs to perform mobility measurement, including a scenario in which the user equipment needs to perform mobility measurement when it moves to the edge of a serving cell, or a scenario in which the user equipment needs to perform mobility measurement periodically, or a scenario in which the user equipment determines that a mobility measurement condition is met based on the signal quality of the serving cell.

In the disclosed embodiment, the user equipment performs mobility measurement on the signal of the serving cell through the low-power receiver to obtain a second measurement result, and determines whether to perform mobility measurement on the signal of the neighboring cell according to the second measurement result, thereby completing the measurement of the neighboring cell according to the measurement result of the serving cell, and successfully completing the mobility measurement when the main transceiver is in a dormancy state in a case that is more in line with the current signal reception state of the user equipment in the serving cell, thereby improving the measurement capability of the user equipment. In addition, the user equipment can move within the coverage area of multiple cells while keeping the main receiver turned off, while ensuring that the user equipment can receive paging from the network, which has the effect of terminal energy saving.

An embodiment of the present disclosure provides a measurement method. FIG. 4 is a flow chart showing a method for performing a measurement according to an exemplary embodiment. As shown in FIG. 4, the method includes steps S401 to S403. Specifically:
Step S401: A network device sends measurement configuration information to a user equipment, where the measurement configuration information is used to indicate that a first reference signal of a neighboring cell with a first priority is used as a measurement signal.

The signal is used for reception by a low-power receiver.

In some possible implementations, the measurement configuration information includes at least one piece of measurement window configuration information, and the measurement window configuration information includes at least one of the following: a window period, a window length, a window time domain offset, and a window frequency domain position. The measurement configuration information may include multiple pieces of different measurement window configuration information. The user equipment may use any measurement window configuration information of the multiple pieces of different measurement window configuration information to perform mobility measurement, or may use different measurement window configuration information under different conditions. This condition may be a time period, a location, etc.

Step S402: The user equipment uses the low-power receiver to measure a second reference signal to obtain a second measurement result, and the user equipment measures the first reference signal of the neighboring cell with the first priority according to the measurement configuration information to obtain a first measurement result.

Step S403: After waking up the main transceiver, the user equipment reports the first measurement result and the second measurement result to the network device.

In an embodiment of the present disclosure, the user equipment performs mobility measurement on the signal of the serving cell through the low-power receiver to obtain the second measurement result. When the network device clearly indicates to the user equipment the neighboring cell that needs to be measured, regardless of the second measurement result (i.e., regardless of the comparison between the second measurement result and the corresponding threshold), the user equipment will use the low-power receiver to measure the first reference signal of the neighboring cell with the first priority according to the instruction of the network device.

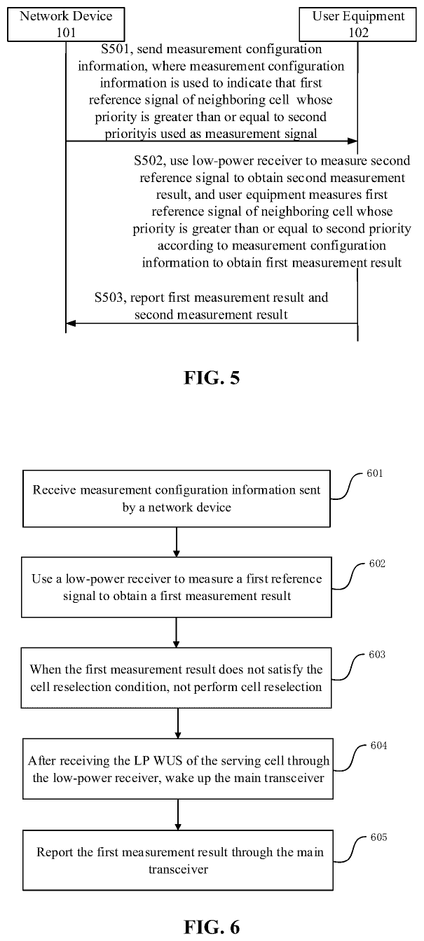

The embodiments of the present disclosure provide a measurement method. FIG. 5 is a flow chart showing a method for performing a measurement according to an exemplary embodiment. As shown in FIG. 5, the method includes steps S501 to S503. Specifically:
Step S501: A network device sends measurement configuration information to a user equipment, where the measurement configuration information is used to indicate that a first reference signal of a neighboring cell whose priority is greater than or equal to a second priority is used as a measurement signal.

The signal is used for reception by a low-power receiver.

In some possible implementations, the measurement configuration information includes at least one piece of measurement window configuration information, and the measurement window configuration information includes at least one of the following: a window period, a window length, a window time domain offset, and a window frequency domain position. The measurement configuration information may include multiple pieces of different measurement window configuration information. The user equipment may use any measurement window configuration information of the multiple pieces of different measurement window configuration information to perform mobility measurement, or may use different measurement window configuration information under different conditions. This condition may be a time period, a location, etc.

Step S502: The user equipment uses the low-power receiver to measure a second reference signal to obtain a second measurement result, and the user equipment measures the first reference signal of the neighboring cell whose priority is greater than or equal to the second priority according to the measurement configuration information to obtain a first measurement result.

Step S503: After waking up the main transceiver, the user equipment reports the first measurement result and the second measurement result to the network device.

In an embodiment of the present disclosure, the user equipment performs mobility measurement on the signal of the serving cell through the low-power receiver to obtain the second measurement result. When the network device clearly indicates to the user equipment the neighboring cell that needs to be measured, regardless of the second measurement result (i.e., regardless of the comparison between the second measurement result and the corresponding threshold), the user equipment will use the low-power receiver to measure the first reference signal of the neighboring cell whose priority is greater than or equal to the second priority according to the instruction of the network device.

An embodiment of the present disclosure provides a measurement method, which is performed by a user equipment. FIG. 6 is a flowchart of a measurement method according to an exemplary embodiment. As shown in FIG. 6, the method includes steps S601-S604. Specifically:
Step S601: Receive measurement configuration information sent by a network device.

The measurement configuration information is used to indicate that a first reference signal is used as a measurement signal, the first reference signal is a signal sent by a neighboring cell of the user equipment, and the signal is used to be received by a low-power receiver.

Since the low-power receiver can receive LP WUS and thus the user equipment can use LP WUS for mobility measurement, the first reference signal can be the low-power wake-up signal. Since the low-power wake-up signal can be periodic, the first reference signal is a periodic low-power wake-up signal.

In view of the fact that, in order to enable the low-power receiver to maintain the local clock, a synchronization signal for maintaining the local clock can be specially designed for the low-power receiver, for example, the synchronization signal can be: an on-off keying (OOK) or frequency shift keying (FSK) modulation signal. Thus, the user equipment can use this synchronization signal to perform mobility measurement, and the first reference signal can be a synchronization signal, and the synchronization signal is used for the low-power receiver to maintain the local clock. Since the synchronization signal can be periodic, the first reference signal is a periodic synchronization signal. This synchronization signal can be a separate synchronization signal independent from the LP WUS, or it can be included in the LP WUS.

In some possible implementations, the measurement configuration information includes at least one piece of measurement window configuration information, and the measurement window configuration information includes at least one of the following: a window period, a window length, a window time domain offset, and a window frequency domain position. The measurement configuration information may include multiple pieces of different measurement window configuration information. The user equipment may use any measurement window configuration information of the multiple pieces of different measurement window configuration information to perform mobility measurement, or may use different measurement window configuration information under different conditions. This condition may be a time period, a geographical location of the user equipment, and the like. For example, different measurement windows correspond to first reference signals to be measured from different neighboring cells. When the user is in a specific geographical location, only the first reference signal of the neighboring cell that is most adjacent to the geographical location is selected for measurement, therefore it is sufficient to measure the first reference signal only in the measurement window corresponding to the neighboring cell.

It can be understood that the signal sent by the neighboring cell of the user equipment is a signal sent by a network device corresponding to the neighboring cell of the serving cell of the user equipment.

Step S602: Use a low-power receiver to measure a first reference signal to obtain a first measurement result.

In some possible implementations, the user equipment using the low-power receiver to measure the first reference signal, including: when the main transceiver of the user equipment is in a dormancy state, the user equipment uses the low-power receiver to measure the first reference signal to obtain the first measurement result.

In some possible implementations, the user equipment using the low-power receiver to measure the first reference signal, including: the user equipment uses the low-power receiver to measure the first reference signal according to configuration information of the first reference signal.

The user equipment may obtain the configuration information of the first reference signal in different ways. For example, the user equipment may obtain the configuration information of the first reference signal in the following two ways:

First, default configuration information is pre-stored in the user equipment, and the configuration information is configuration information of the first reference signal. The configuration information includes at least one of the following: a period, a time domain offset, or a frequency domain position.

Second, the user equipment receives first configuration information sent by the network device, where the first configuration information is configuration information of the first reference signal sent by the neighboring cell, and the first configuration information includes at least one of the following: period, time domain offset, or frequency domain position.

In some possible implementations, the first measurement result is one of the following:
Reference Signal Receiving Power (RSRP),
Received Signal Strength Indicator (RSSI), or
Reference Signal Receiving Quality (RSRQ), where RSRQ is the ratio of RSRP to RSSI.

Step S603: When the first measurement result does not satisfy the cell reselection condition, not perform cell reselection (i.e., be camped in the current serving cell).

In some possible implementations, the cell reselection condition is related to the first measurement result. For example, when the measurement value of the first measurement result does not meet the cell reselection condition, cell reselection is not performed. When the measurement value of the first measurement result meets the cell reselection condition, cell reselection is performed based on the first measurement result.

Step S604: After receiving the LP WUS of the serving cell through the low-power receiver, wake up the main transceiver.

That is, the user equipment is camped in the original serving cell and receives the LP WUS sent by the original serving cell. If the user equipment receives the LP WUS sent by the original serving cell, the user equipment will wake up the main transceiver.

Step S605: Report the first measurement result through the main transceiver.

The embodiments of the present disclosure are applicable to various scenarios in which a user equipment needs to perform mobility measurement, including a scenario in which the user equipment needs to perform mobility measurement when it moves to the edge of a serving cell, or a scenario in which the user equipment needs to perform mobility measurement periodically, or a scenario in which the user equipment determines that a mobility measurement condition is met based on the signal quality of the serving cell.

In the disclosed embodiment, the user equipment performs mobility measurement on the signal of the neighboring cell through the low-power receiver according to the first measurement configuration information configured by the network device, and can smoothly complete the mobility measurement when the main transceiver is in the dormancy state, thereby improving the measurement capability of the user equipment.

The embodiment of the present disclosure provides a measurement method, performed by a user equipment, and the method includes steps S601′-S603′, specifically:
Step S601′ is the same as step S601;
Step S602′ is the same as step S602;
Step S603′: when the first measurement result meets the cell reselection condition, the user equipment performs cell reselection according to the first measurement result, and monitors the LP WUS of the reselected neighboring cell.

In some possible implementations, the cell reselection condition is related to the first measurement result. For example, when the measurement value of the first measurement result does not meet the cell reselection condition, the cell reselection condition is not performed. When the measurement value of the first measurement result meets the cell reselection condition, the cell reselection is performed according to the first measurement result.

In some possible implementations, performing cell reselection according to the first measurement result includes determining at least one neighboring cell according to the first measurement result.

In one example, determining at least one neighboring cell according to the first measurement result includes: determining a neighboring cell that meets at least one of the following conditions according to the first measurement result:
The first measurement result having the highest measured value,
The measured value in the first measurement result being greater than the fifth threshold value, or
The measurement value in the first measurement result being greater than a sixth threshold value and the neighboring cell having the first priority.

In the disclosed embodiment, the user equipment can successfully complete the mobility measurement and cell reselection when the main transceiver is in the dormancy state, thereby improving the measurement capability and cell reselection capability of the user equipment.

After the user equipment completes the cell reselection, the process may further include step S604′.

Step S604′: After receiving the LP WUS of the neighboring cell through the low-power receiver, wake up the main transceiver.

That is, after performing cell reselection, the user equipment receives the LP WUS signal of the neighboring cell determined after the reselection, and determines to wake up the main transceiver accordingly.

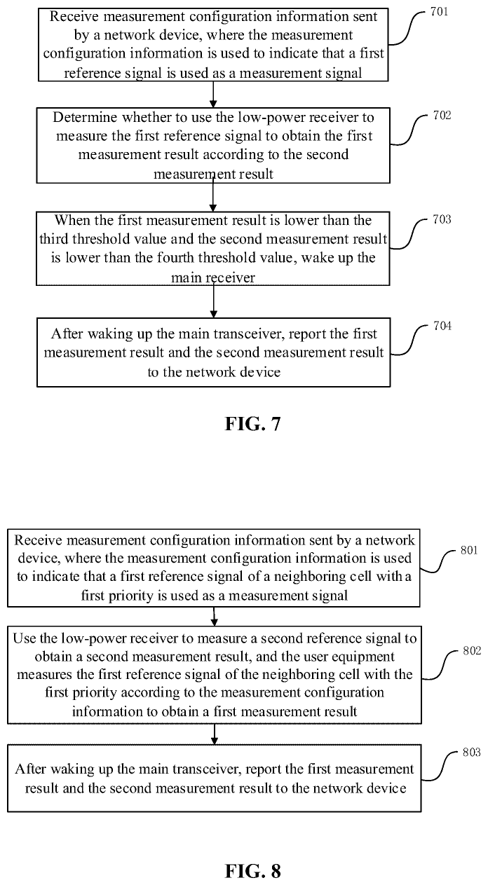

Embodiments of the present disclosure provide a measurement method executed by a user equipment. FIG. 7 is a flow chart of a measurement method according to an exemplary embodiment. As shown in FIG. 7, the method includes steps S701 to S704. Specifically:
Step S701: Receive measurement configuration information sent by a network device, where the measurement configuration information is used to indicate that a first reference signal is used as a measurement signal.

The measurement configuration information is used to indicate that a first reference signal is used as a measurement signal, the first reference signal is a signal sent by a neighboring cell of the user equipment, and the signal is used to be received by a low-power receiver.

Since the low-power receiver can receive LP WUS and thus the user equipment can use LP WUS for mobility measurement, the first reference signal can be a low-power wake-up signal. Since the low-power wake-up signal can be periodic, the first reference signal is a periodic low-power wake-up signal.

In view of the fact that the low-power receiver needs to receive a synchronization signal to maintain a local clock, so that the user equipment can use this synchronization signal to perform mobility measurement, the first reference signal can be a synchronization signal, and the synchronization signal is used for the low-power receiver to maintain the local clock. Since the synchronization signal can be periodic, the first reference signal is a periodic synchronization signal. This synchronization signal can be a separate synchronization signal independent from the LP WUS, or it can be included in the LP WUS.

In some possible implementations, the measurement configuration information includes at least one piece of measurement window configuration information, and the measurement window configuration information includes at least one of the following: a window period, a window length, a window time domain offset, and a window frequency domain position. The measurement configuration information may include multiple pieces of different measurement window configuration information. The user equipment may use any measurement window configuration information of the multiple pieces of different measurement window configuration information to perform mobility measurement, or may use different measurement window configuration information under different conditions. This condition may be a time period, a location, etc.

It can be understood that the signal sent by the neighboring cell of the user equipment is a signal sent by a network device corresponding to a neighboring cell of the serving cell of the user equipment.

Step S702: Use the low-power receiver to measure a second reference signal to obtain a second measurement result, and determine whether to use the low-power receiver to measure the first reference signal to obtain the first measurement result according to the second measurement result.

The second reference signal is a signal sent by a serving cell of the user equipment.

The user equipment may obtain the configuration information of the first reference signal and the configuration information of the second reference signal in different ways. For example:

The ways for obtaining the configuration information of the first reference signal include the following two types:

In the first type, default configuration information is pre-stored in the user equipment, and the configuration information is configuration information of the first reference signal. The configuration information includes at least one of the following: a period, a time domain offset, or a frequency domain position.

In the second type, the user equipment receives first configuration information sent by the network device, where the first configuration information is configuration information of the first reference signal sent by the neighboring cell, and the first configuration information includes at least one of the following: a period, a time domain offset, or a frequency domain position.

The ways for the user equipment to obtain the configuration information of the second reference signal include the following two types:

In the first type, default configuration information is pre-stored in the user equipment, and the configuration information is configuration information of the second reference signal. The configuration information includes at least one of the following: a period, a time domain offset, or a frequency domain position.

In the second type, the user equipment receives second configuration information sent by the network device, where the second configuration information is configuration information of the second reference signal sent by the serving cell, and the second configuration information includes at least one of the following: a period, a time domain offset, or a frequency domain position.

In some possible implementations, determining, according to the second measurement result, to use the low-power receiver to measure the first reference signal includes any one of the following:

The first one is that when the second measurement result is lower than a first threshold value T1, the low-power receiver is used to measure the first reference signal, wherein the frequency of the neighboring cell is the same as the frequency of the serving cell.

It can also be understood that when the second measurement result is lower than the first threshold value T1, the low-power receiver is enabled and used to measure the first reference signal of the neighboring cell with the same frequency as the serving cell.

The second type is that when the second measurement result is lower than a second threshold value T2, the low-power receiver is used to measure the first reference signal, wherein the frequency of the neighboring cell is different from the frequency of the serving cell.

It can also be understood that when the second measurement result is lower than the second threshold value T2, the low-power receiver is enabled and used to measure the first reference signal of the neighboring cell with a frequency different from that of the serving cell.

In some possible implementations, determining not to use the low-power receiver to measure the first reference signal according to the second measurement result includes: when the second measurement result is higher than the first threshold value T1 or the second threshold value T2, not using the low-power receiver to measure the first reference signal. It can also be understood that when the second measurement result is good, there is no need to measure the first reference signal of the neighboring cell.

In some possible implementations, step S702 further includes: determining at least one neighboring cell according to the first measurement result and the second measurement result, and monitoring a low-power wake-up signal of the at least one neighboring cell.

In an example, determining at least one neighboring cell according to the first measurement result and the second measurement result includes at least one of the following:
The first type is that the first measurement result is better than the second measurement result, and the difference between the first measurement result and the second measurement result is greater than or equal to a seventh threshold value; or
The second type is that a value representing the degree to which the first measurement result is superior to the second measurement result is greater than an eighth threshold value.

The value representing the degree may be a ratio of a difference between the first measurement result and the second measurement result to the first measurement result, the second measurement result or a fixed value, or may be a logarithmic representation of the degree to which the first measurement result is superior to the second measurement result.

Step S703: When the first measurement result is lower than the third threshold value and the second measurement result is lower than the fourth threshold value, wake up the main receiver.

In this step S703, if the first measurement result is lower than the third threshold value and the second measurement result is lower than the fourth threshold value, it means that the signal quality of the first reference signal of the neighboring cell and the signal quality of the second reference signal of the serving cell are poor, and it cannot determine how to perform cell reselection using only the low-power receiver. Therefore, the main receiver has to be waken up to perform measurement and determine whether it is needed and how to perform cell reselection.

In one example, the third threshold value is the same as the fourth threshold value, and in another example, the third threshold value is different from the fourth threshold value.

Step S704: After waking up the main transceiver, report the first measurement result and the second measurement result to the network device.

The embodiments of the present disclosure are applicable to various scenarios in which a user equipment needs to perform mobility measurement, including a scenario in which the user equipment needs to perform mobility measurement when it moves to the edge of a serving cell, or a scenario in which the user equipment needs to perform mobility measurement periodically, or a scenario in which the user equipment determines that a mobility measurement condition is met based on the signal quality of the serving cell.

In the disclosed embodiment, the user equipment performs mobility measurement on the signal of the serving cell through the low-power receiver to obtain a second measurement result, and determines whether to perform mobility measurement on the signal of the neighboring cell according to the second measurement result, thereby completing the measurement of the neighboring cell according to the measurement result of the serving cell, and successfully completing the mobility measurement when the main transceiver is in a dormancy state in a case that is more in line with the current signal reception state of the user equipment in the serving cell, thereby improving the measurement capability of the user equipment.

In addition, the user equipment can move within the coverage area of multiple cells while keeping the main receiver turned off, while ensuring that the user equipment can receive paging from the network, which has the effect of terminal energy saving.

An embodiment of the present disclosure provides a measurement method performed by a user equipment. FIG. 8 is a flow chart showing a method for performing a measurement according to an exemplary embodiment. As shown in FIG. 8, the method includes steps S801 to S803. Specifically:
Step S801: Receive measurement configuration information sent by a network device, where the measurement configuration information is used to indicate that a first reference signal of a neighboring cell with a first priority is used as a measurement signal.

The signal is used for reception by a low-power receiver.

In some possible implementations, the measurement configuration information includes at least one piece of measurement window configuration information, and the measurement window configuration information includes at least one of the following: a window period, a window length, a window time domain offset, and a window frequency domain position. The measurement configuration information may include multiple pieces of different measurement window configuration information. The user equipment may use any measurement window configuration information of the multiple pieces of different measurement window configuration information to perform mobility measurement, or may use different measurement window configuration information under different conditions. This condition may be a time period, a location, etc.

Step S802: The user equipment uses the low-power receiver to measure a second reference signal to obtain a second measurement result, and the user equipment measures the first reference signal of the neighboring cell with the first priority according to the measurement configuration information to obtain a first measurement result.

Step S803: After waking up the main transceiver, the user equipment reports the first measurement result and the second measurement result to the network device.

In an embodiment of the present disclosure, the user equipment performs mobility measurement on the signal of the serving cell through the low-power receiver to obtain the second measurement result. When the network device clearly indicates to the user equipment the neighboring cell that needs to be measured, regardless of the second measurement result (i.e., regardless of the comparison between the second measurement result and the corresponding threshold), the user equipment will use the low-power receiver to measure the first reference signal of the neighboring cell with the first priority according to the instruction of the network device.

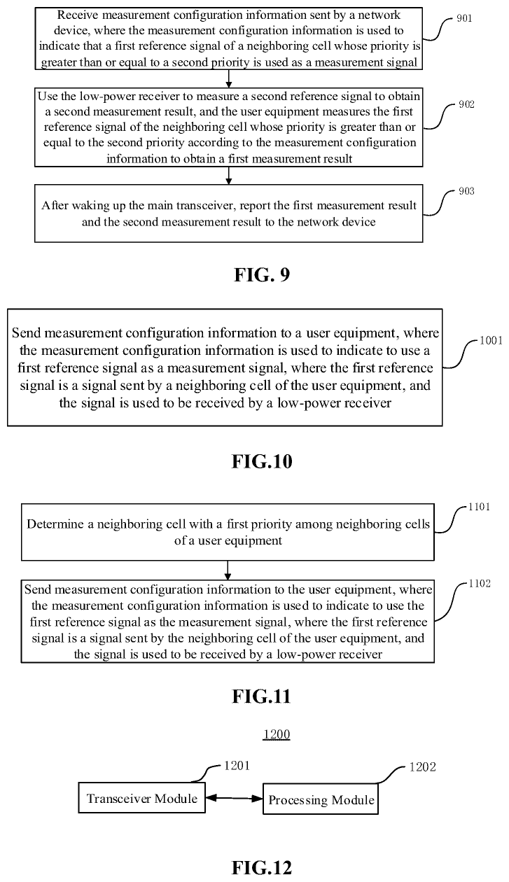

The embodiments of the present disclosure provide a measurement method performed by a user equipment. FIG. 9 is a flow chart showing a method for performing a measurement according to an exemplary embodiment. As shown in FIG. 9, the method includes steps S901 to S903. Specifically:
Step S901: Receive measurement configuration information sent by a network device, where the measurement configuration information is used to indicate that a first reference signal of a neighboring cell whose priority is greater than or equal to a second priority is used as a measurement signal.

The signal is used for reception by a low-power receiver.

In some possible implementations, the measurement configuration information includes at least one piece of measurement window configuration information, and the measurement window configuration information includes at least one of the following: a window period, a window length, a window time domain offset, and a window frequency domain position. The measurement configuration information may include multiple pieces of different measurement window configuration information. The user equipment may use any measurement window configuration information of the multiple pieces of different measurement window configuration information to perform mobility measurement, or may use different measurement window configuration information under different conditions. This condition may be a time period, a location, etc.

Step S902: The user equipment uses the low-power receiver to measure a second reference signal to obtain a second measurement result, and the user equipment measures the first reference signal of the neighboring cell whose priority is greater than or equal to the second priority according to the measurement configuration information to obtain a first measurement result.

Step S903: After waking up the main transceiver, the user equipment reports the first measurement result and the second measurement result to the network device.

In an embodiment of the present disclosure, the user equipment performs mobility measurement on the signal of the serving cell through the low-power receiver to obtain the second measurement result. When the network device clearly indicates to the user equipment the neighboring cell that needs to be measured, regardless of the second measurement result (i.e., regardless of the comparison between the second measurement result and the corresponding threshold), the user equipment will use the low-power receiver to measure the first reference signal of the neighboring cell whose priority is greater than or equal to the second priority according to the instruction of the network device.

An embodiment of the present disclosure provides a method for sending measurement configuration information, which is performed by a network device. FIG. 10 is a flow chart of a method for sending measurement configuration information according to an exemplary embodiment. As shown in FIG. 10, the method includes step S1001, specifically:
Step S1001: Send measurement configuration information to a user equipment, where the measurement configuration information is used to indicate to use a first reference signal as a measurement signal, where the first reference signal is a signal sent by a neighboring cell of the user equipment, and the signal is used to be received by a low-power receiver.

In some possible implementations, the signal is a periodic low-power wake-up signal or a periodic synchronization signal.

In some possible implementations, the first measurement configuration information includes at least one piece of measurement window configuration information, and the measurement window configuration information includes at least one of the following: a window period, a window length, a window time domain offset, and a window frequency domain position.

An embodiment of the present disclosure provides a method for sending measurement configuration information, which is performed by a network device. FIG. 11 is a flow chart of a method for sending measurement configuration information according to an exemplary embodiment. As shown in FIG. 11, the method includes steps S1101-S1102, specifically:
Step S1101, Determine a neighboring cell with a first priority among neighboring cells of a user equipment; and
Step S1102: Send measurement configuration information to the user equipment, where the measurement configuration information is used to indicate to use the first reference signal of the neighboring cell with the first priority as the measurement signal, where the first reference signal is a signal sent by the neighboring cell of the user equipment, and the signal is used to be received by a low-power receiver.

Based on the same concept as the above method embodiment, the embodiment of the present disclosure further provides a communication apparatus, which may have the functions of the user equipment 102 in the above method embodiment, and is used to execute the steps performed by the user equipment 102 provided in the above embodiment. The function may be implemented by hardware, or by software or hardware executing corresponding software. The hardware or software includes one or more modules corresponding to the above functions.

In a possible implementation, the communication apparatus 1200 shown in FIG. 12 may serve as the user equipment 102 involved in the above method embodiment, and execute the steps executed by the user equipment 102 in the above method embodiment.

The communication apparatus 1200 includes a transceiver module 1201 and a processing module 1202.

The transceiver module 1201 is configured to measure a first reference signal using a low-power receiver to obtain a first measurement result, wherein the first reference signal is a signal sent by a neighboring cell of the user equipment, and the first reference signal is used for reception by the low-power receiver.

In some possible implementations, the first reference signal is a periodic low-power wake-up signal or a periodic synchronization signal.

In some possible implementations, the transceiver module 1201 is further configured to: receive measurement configuration information sent by a network device, wherein the measurement configuration information is used to indicate that the first reference signal is used as a measurement signal.

In some possible implementations, the measurement configuration information includes at least one piece of measurement window configuration information, wherein the measurement window configuration information includes at least one of: a window period, a window length, a window time domain offset, or a window frequency domain position.

In some possible implementations, the transceiver module 1201 is further configured to receive first configuration information sent by a network device, wherein the first configuration information is configuration information of the first reference signal sent by the neighboring cell.

In some possible implementations, the first configuration information includes at least one of: a period, a time domain offset, or a frequency domain position.

In some possible implementations, the transceiver module 1201 is further configured to: measuring a second reference signal using the low-power receiver to obtain a second measurement result, wherein the second reference signal is a signal sent by a serving cell of the user equipment.

In some possible implementations, the transceiver module 1201 is further configured to: receive second configuration information sent by a network device, where the second configuration information is configuration information of the second reference signal sent by the serving cell.

In some possible implementations, the transceiver module 1201 is further configured to determine, according to the second measurement result, whether to measure the first reference signal using the low-power consumption receiver to obtain the first measurement result.

In some possible implementations, the transceiver module 1201 is further configured to: in a case that the second measurement result is lower than a first threshold value, measure the first reference signal using the low-power receiver, wherein a frequency of the neighboring cell is the same as a frequency of the serving cell; or, in a case that the second measurement result is lower than a second threshold value, measure the first reference signal using the low-power receiver, wherein the frequency of the neighboring cell is different from the frequency of the serving cell.

In some possible implementations, the transceiver module 1201 is further configured to: wake up a main receiver in a case that the first measurement result is lower than a third threshold value and the second measurement result is lower than a fourth threshold value.

In some possible implementations, the measurement configuration information is used to indicate that the first reference signal of the neighboring cell with a first priority is used as the measurement signal.

In some possible implementations, the transceiver module 1201 is further configured to: determine at least one neighboring cell according to the first measurement result, and monitor the low-power wake-up signal of the at least one neighboring cell.

In some possible implementations, the transceiver module 1201 is further configured to: determine a neighboring cell that meets at least one of following conditions according to the first measurement result:
a measurement value in the first measurement result being highest;
the measurement value in the first measurement result being greater than a fifth threshold value; or
the measurement value in the first measurement result being greater than a sixth threshold value and the neighboring cell having a first priority.

In some possible implementations, the transceiver module 1201 is further configured to: determine at least one neighboring cell according to the first measurement result and the second measurement result, and monitor a low-power wake-up signal of the at least one neighboring cell.

In some possible implementations, the transceiver module 1201 is further configured to determine a neighboring cell satisfying at least one of: the first measurement result being better than the second measurement result, and a difference between the first measurement result and the second measurement result being greater than or equal to a seventh threshold value; or
a value representing a degree to which the first measurement result is superior to the second measurement result being greater than an eighth threshold value.

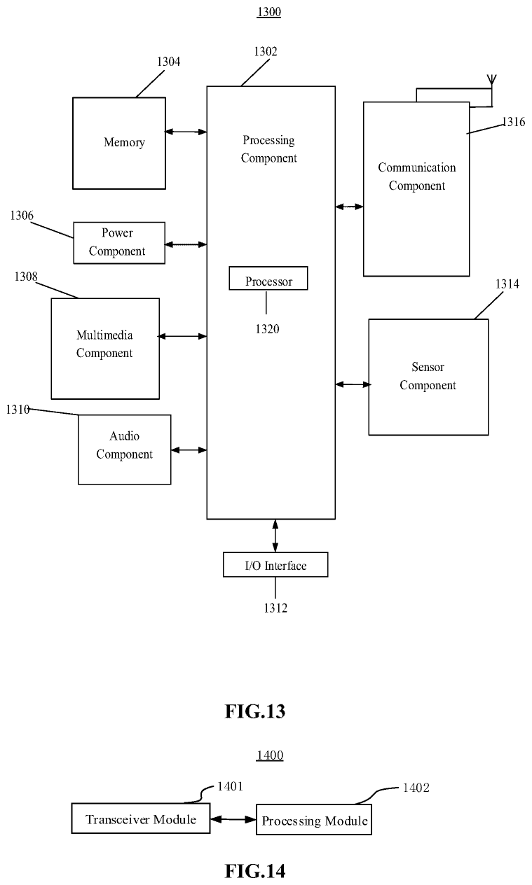

When the communication apparatus is user equipment 102, its structure may also be as shown in FIG. 13.

Referring to FIG. 13, the apparatus 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 generally controls the overall operations of the apparatus 1300, such as operations associated with display, telephone calls, data communications, camera operations, and recording operations. The processing component 1302 may include one or more processors 1320 to execute instructions to complete all or part of the steps of the above method. Additionally, processing component 1302 may include one or more modules that facilitate interaction between processing component 1302 and other components. For example, processing component 1302 may include a multimedia module to facilitate interaction between multimedia component 1308 and processing component 1302.

The memory 1304 is configured to store various types of data to support operations at the device 1300. Examples of such data include instructions for any application or method operating on the apparatus 1300, contact data, phonebook data, messages, pictures, videos, etc. The memory 1304 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power component 1306 provides power to various components of the apparatus 1300. The power component 1306 may include a power management system, one or more power supplies, and other components associated with generating, managing, and distributing power for apparatus 1300.

The multimedia component 1308 includes a screen providing an output interface between the apparatus 1300 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 1308 includes a front camera and/or a rear camera. When the device 1300 is in an operation mode, such as a photographing mode or a video mode, the front camera and/or the rear camera can receive external multimedia data. Each front camera and rear camera can be a fixed optical lens system or have focal length and optical zoom capability.

The audio component 1310 is configured to output and/or input audio signals. For example, the audio component 1310 includes a microphone (MIC), which is configured to receive an external audio signal when the apparatus 1300 is in an operation mode, such as a call mode, a recording mode and a voice recognition mode. Received audio signals may be further stored in memory 1304 or sent via communication component 1316. In some embodiments, the audio component 1310 also includes a speaker for outputting audio signals.

The I/O interface 1312 provides an interface between the processing component 1302 and a peripheral interface module, which may be a keyboard, a click wheel, a button, and the like. These buttons may include, but are not limited to: a home button, volume buttons, start button, and lock button.

The sensor component 1314 includes one or more sensors for providing apparatus 1300 with various aspects of status assessment. For example, the sensor component 1314 can detect the open/closed state of the apparatus 1300, the relative positioning of components, such as the display and the keypad of the apparatus 1300, the sensor component 1314 can also detect the apparatus 1300 or a change in the position of a component of the apparatus 1300, the presence or absence of user's contact with the apparatus 1300, the change of orientation or acceleration/deceleration of the apparatus 1300 and the temperature change of the apparatus 1300. The sensor component 1314 may include a proximity sensor configured to detect the presence of nearby objects in the absence of any physical contact. The sensor component 1314 may also include an optical sensor, such as a CMOS or CCD image sensor, for use in imaging applications. In some embodiments, the sensor component 1314 may also include an acceleration sensor, a gyroscope sensor, a magnetic sensor, a pressure sensor or a temperature sensor.

The communication component 1316 is configured to facilitate wired or wireless communication between the apparatus 1300 and other devices. The apparatus 1300 can access a wireless network based on communication standards, such as Wi-Fi, 4G or 5G, or a combination thereof. In an exemplary embodiment, the communication component 1316 receives broadcast signals or broadcast related information from an external broadcast management system via a broadcast channel. In an exemplary embodiment, the communication component 1316 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, apparatus 1300 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

In an exemplary embodiment, there is also provided a non-transitory computer-readable storage medium including instructions, such as the memory 1304 including instructions, which can be executed by the processor 1320 of the apparatus 1300 to implement the above method. For example, the non-transitory computer readable storage medium may be ROM, random access memory (RAM), CD-ROM, magnetic tape, floppy disk, and optical data storage device, and the like.

Based on the same concept as the above method embodiment, the embodiment of the present disclosure also provides a communication apparatus, which can have the function of the network device 101 in the above method embodiment, and is used to execute the steps performed by the network device 101 provided in the above embodiment. The function can be implemented by hardware, or by software or hardware executing corresponding software. The hardware or software includes one or more modules corresponding to the above functions.

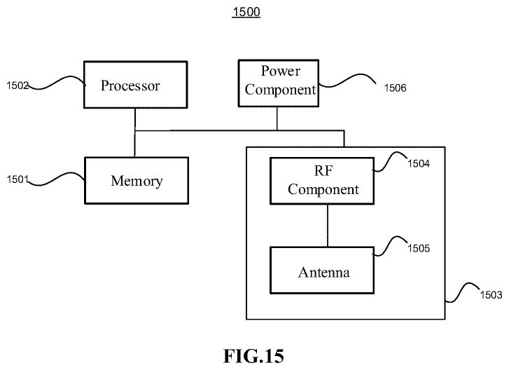

In a possible implementation, the communication apparatus 1400 shown in FIG. 14 may be used as the network device 101 involved in the above method embodiment, and execute the steps performed by the network device 101 in the above method embodiment.

The communication apparatus 1400 includes a processing module 1402, or includes a transceiver module 1401 and a processing module 1402.

The transceiver module 1401 is configured to send measurement configuration information to the user equipment, where the measurement configuration information is used to indicate that a first reference signal is used as a measurement signal, where the first reference signal is a signal sent by a neighboring cell of the user equipment, and the signal is used to be received by a low-power receiver.

In a possible implementation, the signal is a periodic low-power wake-up signal or a periodic synchronization signal.

In a possible implementation, the first measurement configuration information includes at least one piece of measurement window configuration information, and the measurement window configuration information includes at least one of the following: a window period, a window length, a window time domain offset, and a window frequency domain position.

In a possible implementation manner, the transceiver module 1401 is configured to: send first configuration information to the user equipment, where the first configuration information is configuration information of the first reference signal sent by the neighboring cell.

In a possible implementation manner, the transceiver module 1401 is configured to: send second configuration information to the user equipment, where the second configuration information is configuration information of the second reference signal sent by the serving cell.

In a possible implementation, the processing module 1402 is configured to determine a neighboring cell with a first priority among neighboring cells of the user equipment; and the measurement configuration information is used to indicate to use a first reference signal of the neighboring cell with the first priority as a measurement signal.

When the communication apparatus is a network device, its structure can also be shown in FIG. 15. Take the network device 101 as a base station as an example to illustrate the structure of the communication apparatus. As shown in FIG. 15, the device 1500 includes a memory 1501, a processor 1502, a transceiver component 1503, and a power component 1506. In the embodiment, the memory 1501 is coupled to the processor 1502, and can be used to store the programs and data necessary for the communication apparatus 1500 to implement various functions. The processor 1502 is configured to support the communication apparatus 1500 to perform the corresponding functions in the above method, and this function can be implemented by calling the program stored in the memory 1501. The transceiver component 1503 can be a wireless transceiver, which can be used to support the communication apparatus 1500 to receive signaling and/or data through a wireless air interface, and send signaling and/or data. The transceiver component 1503 may also be referred to as a transceiver unit or a communication unit. The transceiver component 1503 may include a radio frequency component 1504 and one or more antennas 1505, wherein the radio frequency component 1504 may be a remote radio unit (RRU), which may be specifically used for transmitting radio frequency signals and converting radio frequency signals into baseband signals, and the one or more antennas 1505 may be specifically used for radiating and receiving radio frequency signals.

When the communication apparatus 1500 needs to send data, the processor 1502 can perform baseband processing on the data to be sent, and then output the baseband signal to the RF unit. The RF unit performs RF processing on the baseband signal and then sends the RF signal in the form of electromagnetic waves through the antenna. When data is sent to the communication apparatus 1500, the RF unit receives the RF signal through the antenna, converts the RF signal into a baseband signal, and outputs the baseband signal to the processor 1502. The processor 1502 converts the baseband signal into data and processes the data.

In an exemplary embodiment, a non-transitory computer-readable storage medium including instructions is also provided, such as a memory 604 including instructions, and the instructions can be executed by a processor 620 of the apparatus 600 to perform the above method. For example, the non-transitory computer-readable storage medium can be a ROM, a random access memory (RAM), a CD-ROM, a magnetic tape, a floppy disk, an optical data storage device, etc.

Those skilled in the art will readily appreciate other implementations of the disclosed embodiments after considering the specification and practicing the invention disclosed herein. This application is intended to cover any variations, uses, or adaptations of the disclosed embodiments, which follow the general principles of the disclosed embodiments and include common knowledge or customary technical means in the art that are not disclosed in the present disclosure. The specification and examples are to be considered as exemplary only, and the true scope and spirit of the disclosed embodiments are indicated by the following claims.

It should be understood that the embodiments of the present disclosure are not limited to the precise structures described above and shown in the drawings, and various modifications and changes may be made without departing from the scope thereof. The scope of the embodiments of the present disclosure is limited only by the appended claims.

### INDUSTRIAL APPLICABILITY

The user equipment performs mobility measurement on the signals of the neighboring cells through the low-power receiver, and can smoothly complete the mobility measurement when the main transceiver is in the dormancy state, thereby improving the measurement capability of the user equipment.

1. A measurement method, performed by a user equipment, the method comprising:
measuring a first reference signal using a low-power receiver to obtain a first measurement result, wherein the first reference signal is a signal sent by a neighboring cell of the user equipment, and the first reference signal is used for reception by the low-power receiver.

2. The method according to claim 1, wherein the first reference signal is a periodic low-power wake-up signal or a periodic synchronization signal.

3. The method according to claim 1, wherein the method further comprises:
receiving measurement configuration information sent by a network device, wherein the measurement configuration information is used to indicate that the first reference signal is used as a signal for measurement by the low-power receiver.

4. The method according to claim 3, wherein the measurement configuration information comprises at least one piece of measurement window configuration information, wherein the measurement window configuration information comprises at least one of: a window period, a window length, a window time domain offset, or a window frequency domain position.

5. The method according to claim 1, wherein the method further comprises:
receiving first configuration information sent by a network device, wherein the first configuration information is configuration information of the first reference signal sent by the neighboring cell.

6. The method according to claim 5, wherein the first configuration information comprises at least one of: a period, a time domain offset, or a frequency domain position.

7. The method according to claim 1, wherein the method further comprises:
measuring a second reference signal using the low-power receiver to obtain a second measurement result, wherein the second reference signal is a signal sent by a serving cell of the user equipment.

8. The method according to claim 7, wherein the method further comprises:
receiving second configuration information sent by a network device, where the second configuration information is configuration information of the second reference signal sent by the serving cell.

9. The method according to claim 7, wherein the measuring the first reference signal using the low-power receiver comprises:
determining, according to the second measurement result, whether to measure the first reference signal using the low-power consumption receiver to obtain the first measurement result.

10. The method according to claim 9, wherein determine, according to the second measurement result, to measure the first reference signal using the low-power consumption receiver, comprises:
in a case that the second measurement result is lower than a first threshold value, measuring the first reference signal using the low-power receiver, wherein a frequency of the neighboring cell is the same as a frequency of the serving cell;
or,
in a case that the second measurement result is lower than a second threshold value, measuring the first reference signal using the low-power receiver, wherein the frequency of the neighboring cell is different from the frequency of the serving cell.

11. The method according to claim 7, wherein the method further comprises:
waking up a main receiver in a case that the first measurement result is lower than a third threshold value and the second measurement result is lower than a fourth threshold value.

12. The method according to claim 3, wherein the method further comprises:
using the measurement configuration information to indicate that the first reference signal of the neighboring cell with a first priority is used as the measurement signal.

13. The method according to claim 1, wherein the method further comprises:
determining at least one neighboring cell according to the first measurement result, and monitoring the low-power wake-up signal of the at least one neighboring cell.

14. The method according to claim 13, wherein determining at least one neighboring cell according to the first measurement result comprises:
determining a neighboring cell that meets at least one of following conditions according to the first measurement result:
a measurement value in the first measurement result being highest;
the measurement value in the first measurement result being greater than a fifth threshold value; or
the measurement value in the first measurement result being greater than a sixth threshold value and the neighboring cell having a first priority.

15. The method according to 7, wherein the method further comprises:
determining at least one neighboring cell according to the first measurement result and the second measurement result, and monitoring a low-power wake-up signal of the at least one neighboring cell.

16. The method according to claim 15, wherein the determining at least one neighboring cell according to the first measurement result and the second measurement result comprises: determining a neighboring cell satisfying at least one of:
the first measurement result being better than the second measurement result, and a difference between the first measurement result and the second measurement result being greater than or equal to a seventh threshold value; or
a value representing a degree to which the first measurement result is superior to the second measurement result being greater than an eighth threshold value.

17. A method for sending measurement configuration information, performed by a network device, the method comprising:
sending measurement configuration information to a user equipment, wherein the measurement configuration information is used to indicate that a first reference signal is used as a signal for measurement by the low-power receiver, wherein the first reference signal is a signal sent by a neighboring cell of the user equipment, and the signal is used for reception by a low-power receiver.

18. The method according to claim 17, wherein,
the signal is a periodic low-power wake-up signal or a periodic synchronization signal.

19.-24. (canceled)

25. An electronic device, comprising a processor and a memory, wherein:
the memory is configured to store a computer program; and
the processor is configured to execute the computer program to implement a measurement method comprising:
measuring a first reference signal using a low-power receiver to obtain a first measurement result, wherein the first reference signal is a signal sent by a neighboring cell of the electronic device equipment, and the signal is used for reception by the low-power receiver.

26. An electronic device, comprising a processor and a memory, wherein:
the memory is configured to store a computer program; and
the processor is configured to execute the computer program to implement the method according to claim 17.

27.-28. (canceled)
